(19) United States
(12) Patent Application Publication
(10) Pub. No.: US 2024/0078444 A1
(43) Pub. Date: Mar. 7, 2024

(54) VEHICLE FAULT REASONING METHOD BASED ON KNOWLEDGE GRAPH

(71) Applicant: SHANGHAI UNIVERSITY of ENGINEERING SCIENCE, Shanghai (CN)

(72) Inventors: Zhijun Fang, Shanghai (CN); Yuanyuan Li, Shanghai (CN); Yongbin Gao, Shanghai (CN); Weibing Wan, Shanghai (CN)

(73) Assignee: SHANGHAI UNIVERSITY of ENGINEERING SCIENCE, Shanghai (CN)

(21) Appl. No.: 17/987,824

(22) Filed: Nov. 15, 2022

(30) Foreign Application Priority Data
Sep. 1, 2022 (CN) 202211066077.X

(51) Int. Cl. G06N 5/02; G06F 16/951; G06N 5/00; G07C 5/08

(52) U.S. Cl. CPC G06N 5/022; G06F 16/951; G06N 5/003; G07C 5/0816

(57) ABSTRACT

The invention discloses a vehicle fault reasoning method based on a knowledge graph, includes: constructing a knowledge graph of a vehicle fault; obtaining a question statement (QS) from user; performing question classification on the QS by TextCNN to obtain a classification result; marking a training QS by using an NER data marking manner and training an entity extraction model based on a sequence marking result; generating a vehicle fault class by a decision tree model for extracting the QS and searching for an answer in the knowledge graph; and performing question template matching based on the classification result and the answer and substituting the answer into the question template to obtain an answer statement. A question answering system constructed by the method includes word processing, question classification, question template matching, and answer generation, which helps the user judging a fault problem of vehicle, and searching for related knowledge about vehicle fault.

### CROSS-REFERENCE TO RELATED APPLICATION

This application claims the priority benefit of China application serial no. 202211066077.X, filed on Sep. 1, 2022. The entirety of the above-mentioned patent application is hereby incorporated by reference herein and made a part of this specification.

### BACKGROUND OF THE INVENTION

### Technical Field

The present invention relates to the field of vehicle engineering, and in particular, to a vehicle fault reasoning method based on a knowledge graph.

### Description of Related Art

New energy vehicles have become an indispensable part in the lives of people. With the rapid development of vehicle industries, there are more and more types and quantities of modern vehicles, and safety performance of vehicle running has become the primary problem for people to consider, so it is necessary to improve a vehicle fault diagnosis technology. In the early 1960s, western countries have begun to study vehicle diagnosis technologies. As more and more technologies are applied to vehicles, internal structure of the vehicles become more and more complex while internal functions are complete, which lead to the emergence of more and more new fault types, and therefore, new fault diagnosis methods are needed to deal with more fault problems. China starts late in the field of vehicle fault diagnosis technologies, and due to limited economic strength, related technologies lag behind that of developed countries abroad. However, the formulation of some policies in line with China's national conditions has been very timely. Soon after the formulation of a new energy vehicle development incentive policy, most of the major domestic vehicle enterprises and research universities have seized the opportunity to actively carry out research on a service system of electric vehicle diagnosis and service under the promotion of the policy, and achieved remarkable results.

Fault diagnosis methods are mainly divided into a fault diagnosis method based on a physical model, a fault diagnosis method based on experience knowledge, and a fault diagnosis method based on data driving. The fault diagnosis method based on the physical model generally needs to have very clear recognition on a structure, a principle, etc., of a research object, thereby establishing a mathematical model between data of the research object and the fault type. However, in actual application, it is very difficult to construct a mathematical and physical model that is used to describe a complex device. Therefore, limitations of this method are highlighted in the era of increasingly complex vehicle mechanical device systems. The fault diagnosis method based on the experience knowledge mainly relies on years of practice and theoretical knowledge accumulation of the research object, among which an expert system application fault diagnosis method is the most widely applied, which requires long-term practical experience and solid theoretical expertise of experts in related fields. More dependence on the experience and technical level of the maintenance personnel for the vehicle industry, and there is a higher time cost, which may lead to wrong analysis of a fault reason and miss the best time for diagnosis. The fault diagnosis method based on the data driving is mainly to process the acquired fault data to obtain a diagnosis result. In the foreign research field, for a fault signal, a method combining envelope detection and Fourier transform may be used, and then a feature is extracted to perform fault classification; a self-organizing map neural network is also used to perform gear fault diagnosis. In China, feature extraction methods such as wavelet packet transform are mainly used to perform the fault classification, and a stack noise reduction self-encoder is also used to extract a data feature combining a current signal and a vibration signal, to implement a motor fault diagnosis technology combined with a softmax classifier. However, it is difficult to solve a fault problem of a plurality of fault types and knowledge being associated with data by singly using fault mechanisation or running data alone, and the value of data cannot be fully exerted.

### BRIEF SUMMARY OF THE INVENTION

In view of the above defects in the prior art, the present invention provides a vehicle fault reasoning method based on a knowledge graph, and promotes vehicle fault knowledge and provides fast vehicle fault maintenance consulting service by establishing a fast semantic fault question answering system. The system uses a BiLSTM-CRF algorithm to perform vehicle fault information extraction among questions, can recognize main fault information of a vehicle timely, helps a user to perform vehicle defect class recognition by means of a decision tree algorithm, and may also help a consultant to learn related knowledge by means of knowledge question and answer. The present research helps the consultant to reduce the cage of prior knowledge, make up for the shortage of vehicle maintenance personnel, and improve the quality of vehicle after-sales maintenance.

In order to achieve the above purpose, the present invention provides a vehicle fault reasoning method based on a knowledge graph, the method including:
constructing a knowledge graph of a vehicle fault;
obtaining a question statement of a user;
performing question classification on the question statement by means of TextCNN to obtain a classification result;
performing sequence marking on a training question statement by using a method of NER marking sequence and training an entity extraction model based on a sequence marking result;
generating a vehicle fault class by using a decision tree model to make a decision on a result of the entity extraction model extracting the question statement and searching for an answer in the knowledge graph based on the vehicle fault class; and
performing question template matching based on the question classification result and the answer and substituting the answer into the question template to obtain an answer statement.

Further improvement of the present invention is that the constructing a knowledge graph of a vehicle fault includes the following steps:
crawling Internet data related to the vehicle fault by means of a crawler and sorting out the Internet data combined with vehicle fault data into structured data; and
constructing the knowledge graph by using the structured data.

Further improvement of the present invention is that the entity extraction model is a BiLSTM-CRF model including an Embedding layer, a two-way LSTM layer, and a CRF layer.

Further improvement of the present invention is that types of a voice text include fault recognition, factual questions, method questions, list questions, and other questions.

Further improvement of the present invention is that the question template matching specifically includes: performing multi-pattern string matching by using an AC algorithm; and the AC algorithm including a Trie tree and a fail pointer, and the Trie tree including an AC tree of each entity type.

### BRIEF DESCRIPTION OF THE SEVERAL VIEWS OF THE DRAWINGS

FIG. 1 is a structural diagram of BiLSTM-CRF;

FIG. 2 is a framework of a vehicle fault question answering system;

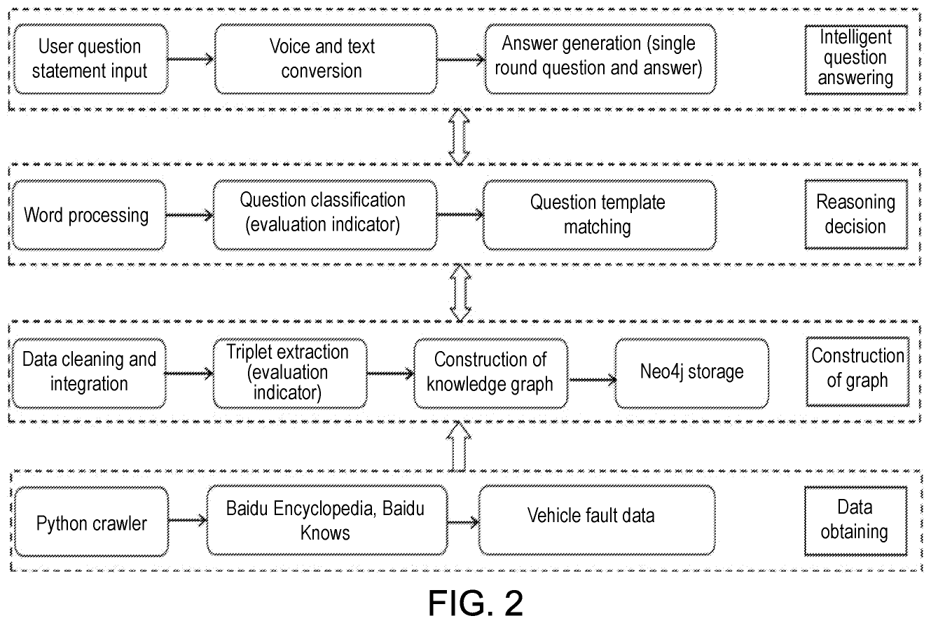

FIG. 3 is a vehicle fault question answering interface; and

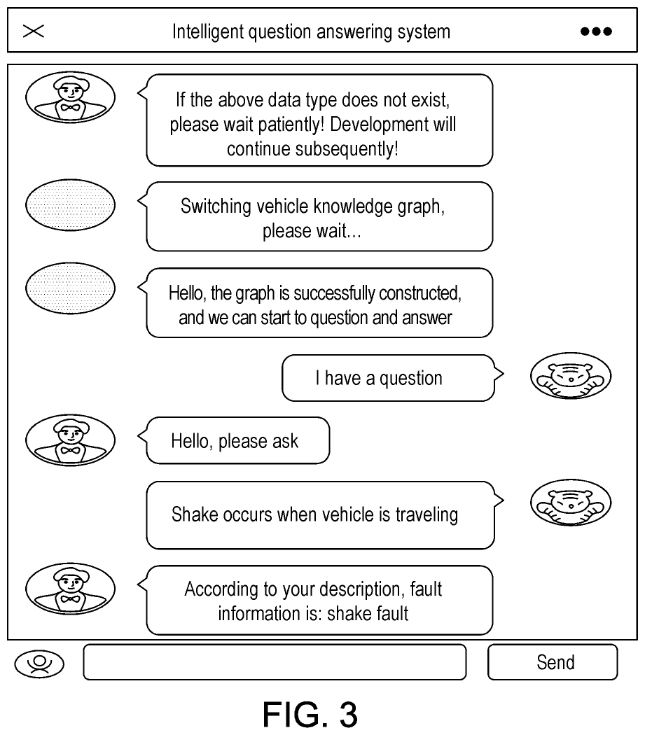

FIG. 4 is another question answering interface.

### DETAILED DESCRIPTION OF THE INVENTION

Implementations of the present invention will be described below by means of specific examples, and those skilled in the art may easily learn other advantages and effects of the present invention from the content disclosed in the specification. The present invention may also be implemented or applied by means of another different specific implementation, and various modifications and alterations may also be made to various details in the specification based on different views and applications without departing from the spirit of the present invention. It should be noted that the following embodiments and features in the embodiments may be combined with each other without conflict.

For illustrative purposes, some exemplary embodiments of the present invention are described, and it should be understood that the present invention may be implemented by other methods not specifically shown in the accompanying drawings.

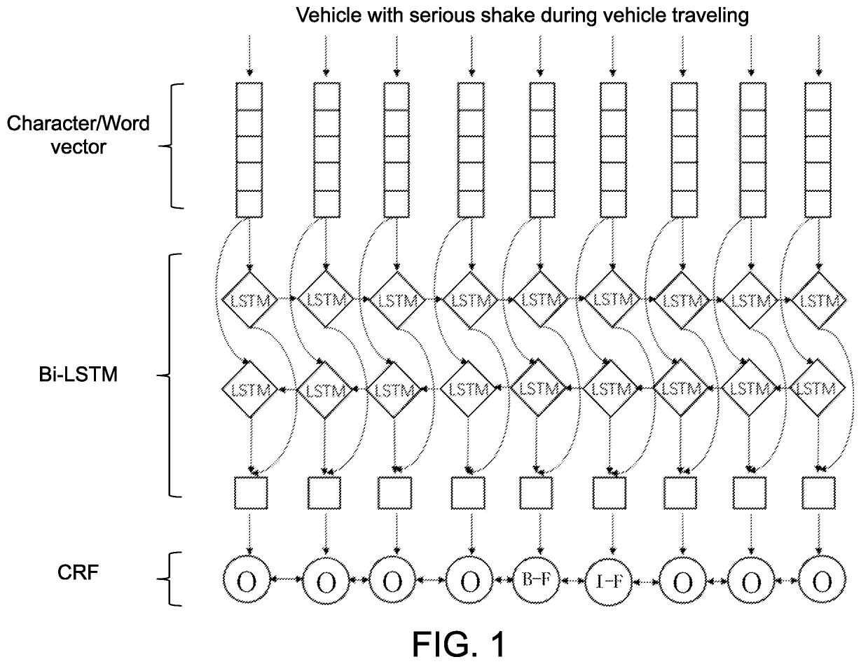

Embodiment: please refer to FIG. 1, the question answering system constructed by the present invention is inclined to obtain new energy vehicle fault expertise, and the purpose is to help people with new energy vehicle faults to find a correct answer. A framework of vehicle fault detection question answering system mainly includes four parts: data obtaining, graph construction, question understanding, and a user interface. An obtaining module of the system obtains related web page data by means of a crawler technology, then sorts out the related web page data into structured data by means of data processing combined with the existing vehicle fault data, and uses python to drive py2neo to perform construction of the knowledge graph in Neo4j.

A question understanding module converts a question statement to a TF-IDF matrix, and question classification is performed in a TextCNN model. When a question is divided into a question of a fault recognition class, a vehicle fault class thereof is judged by means of a decision tree model, and finally, an AC*algorithm is used to match in a question answer template and generate an answer. A user interface module is a question statement input of a user and system answer feedback, and relates to mutual conversion of voice and a text.

I. Construction of a Knowledge Graph

The knowledge graph is divided into a data layer and a mode layer, where the data layer is composed of a series of factual data, and the mode layer is used to construct an entity, an attribute, and a relationship from data, and is the core of the knowledge graph. An ontology library is widely used to construct the data layer of the knowledge graph, and the knowledge graph constructed by the ontology library has less redundancy and has a strong structure level. Ontologies of the knowledge graph constructed by the present invention respectively are: Monthly, stationed abroad, repair time, a license plate number, operating mileage, a user name, a defect class, market bad description, a troubleshooting solution, a preliminary judgment conclusion, a final measure of the whole vehicle, and responsibility judgment. Starting from the vehicle plate number, entities that are directly related to the vehicle plate number are the Monthly, the stationed abroad, the repair time, the operating mileage, the user name, and the market bad description. The defect class of the vehicle may be obtained based on the market bad description, and the preliminary judgment conclusion may be obtained based on the troubleshooting solution and the final measure of the whole vehicle. After the ontology library is constructed, mapping of the entities in the graph may be performed to construct the knowledge graph.

The knowledge graph is a special knowledge base using pictures to store. A structure of the knowledge graph is as shown in the figure, and mainly includes elements such as an entity, an entity attribute, a relationship, and a relationship attribute. The entity in the knowledge graph exists in a node form, and the relationship exists in a directed edge manner. Entities are connected by means of the relationship to finally form a triplet structure of “entity-relationship-entity”, where the attribute is used to describe some features included in the entity or the relationship. The construction of the knowledge graph is mainly divided into three steps: knowledge extraction, knowledge fusion, and knowledge processing. The knowledge extraction is mainly to extract a needed entity, attribute, and relationship from structured data or non-structured data. The knowledge fusion is mainly to perform operations such as entity disambiguation, coreference resolution on information of the knowledge extraction. Extracted information is combined into a triplet form to form a preliminary knowledge graph. The knowledge processing is mainly to perform effect evaluation and updating on the preliminary knowledge graph, to meet a demand of an application.

The knowledge extraction is generally divided into two types: entity extraction and relationship extraction. The entity extraction is mainly to intensively extract a word that can represent the entity or the attribute from a vehicle fault analysis corpus, where the word may enable the dimension of an entity concept set in the knowledge graph to be constructed completely, and an entity extraction result is a node in the knowledge graph, and during a process of extraction, it should be considered that an application and visual display are satisfied under a condition of minimum redundancy degree. Manners of representation of the entity and the attribute of the vehicle fault knowledge graph are as shown in Table 1.

TABLE 1
Some examples of entities and attributes thereof

| | Attribute | | |
|---|---|---|---|
| Entity | name | Attribute | Label (node type) |
| Serious abnormal | Descrip- | Bad | Market bad |
| noise of vehicle | tion | information | description |
| during traveling | | | |
| Abnormal noise | Class | Defect | Defect class |
| fault | | | |
| Power-on test | Solution | Trouble- | Troubleshooting |
| | | shooting | solution |
| DCDC fault | Conclusion | Final | Preliminary judgment |
| | | | conclusion |
| Replacing DC | Measure | Measure | Final measure of the |
| insurance | | | whole vehicle |
| Yes | Respon- | Judgment | Responsibility |
| | sibility | | judgment |
| Gui AXXXD | License plate | Number | License plate number |
| | number | | |
| Wuhan | Stationed | Wuhan | Stationed abroad |
| | abroad | | |
| 2020 Jan. 20 | Time | Repair | Repair time |

The relationship extraction is mainly to extract a semantic relationship between entities from a vehicle fault analysis corpus, describes an internal association relationship of each entity, and is an indispensable step for providing a searching function and a visual display. The vehicle knowledge graph defines the relationship by means of the entity and the attribute thereof, and some examples of the relationship extraction are as shown in Table 2.

TABLE 2
Some examples of relationship extraction

| | | Rela- |
|---|---|---|
| Entity 1 | Entity 2 | tionship |
| Market bad description | Defect class | Belonging |
| Troubleshooting solution | Defect class | Belonging |
| Preliminary judgment conclusion | Market bad description | Belonging |
| Final measure of the whole vehicle | Preliminary judgment | Belonging |
| | conclusion | |
| Responsibility judgment | Final measure of the | Belonging |
| | whole vehicle | |
| Preliminary judgment conclusion | Defect class | Belonging |
| Stationed abroad | License plate number | Belonging |

Public data is collected and sorted out by means of a crawler and the vehicle fault knowledge analysis and corpus are intensively sorted out and provided, and formation of a bearing fault knowledge graph system is completed by means of extraction of related knowledge such as an entity and a relation diagram. At present, 8,693 entity nodes and 21,586 relationships are established in a graph database in total.

II. Vehicle Fault Question Classification

Combined with obtained vehicle after-sale fault maintenance data, the present invention divides common questions into five classes respectively being fault recognition, factual questions, method questions, list questions, and other questions. The fault recognition questions mainly answer “what fault”, the factual questions mainly answer “what”, the method questions mainly answer “how”, and the list questions mainly answer “which”.

TABLE 1
Vehicle fault question answering question classification

| Order | | |
|---|---|---|
| number | Question type | Question example |
| 1 | Fault | I feel the front of my car is shaking all the |
| | recognition | time, what's wrong with my car |
| 2 | Factual question | Why does vehicle shake fault occur |
| 3 | Method question | How to deal with vehicle shake fault |
| 4 | List question | What are the similar cases of vehicle shake |
| | | fault |

First, question type classification is performed on an input text by means of TextCNN, and the present invention will classify the input question in detail using a decision tree manner if the question is the fault recognition question. For a Chinese text being mapped as a TF-IDF matrix, the present invention uses a TF-IDF matrix manner. TF-IDF is a statistical analysis method for key words and is used to evaluate the importance of a word to a file set or a corpus. The importance of a word is directly proportional to the number of times the word appears in the article, and inversely proportional to the number of times the word appears in the corpus. This calculation method can effectively avoid the influence of common words on the keywords and improve a correlation between the keywords and articles.

III. Entity Extraction Model

BiLSTM-CRF intuitively shows a model structure and advantages, where BiLSTM learns past and future information that a character in the sequence depends on by means of forward/backward transmission, and CRF considers rationality of a marking sequence. The model is mainly composed of an Embedding layer (mainly a word vector and other additional features), a two-way LSTM layer, and a final CRF layer. In terms of features, the model inherits advantages of a deep learning method, and may achieve a good effect by using the word vector and a character vector without feature engineering, and if there are high-quality dictionary features, the model can be further improved.

The two-way LSTM layer is introduced as a feature extraction means, and LSTM has a strong long sequence feature extraction capability. When a time feature is extracted, two-way LSTM can use information of a sequence after the time, which can undoubtedly improve the feature extraction capability of the model. The CRF is introduced as a decoding means. After the two-way LSTM layer decodes a Chinese input, rich information being decoded needs to be used to convert the Chinese input to an NER marking sequence.

By observing the sequence, a hidden state sequence is predicted, and the CRF is undoubtedly the first choice.

IV. Question Template Matching

An aho-corasick (AC) algorithm includes a Trie tree and a fail pointer, and when multi-pattern string matching is performed, a plurality of time complexity is reduced compared with a traditional algorithm. The present invention constructs different entity types of AC tree by means of the AC algorithm, and adds all entities to the tree. When the system is used, a principle thereof is matching of a dictionary. When the system obtains a question input by a user, question class classification is first performed, and when the question is divided into the fault recognition question, entity extraction is performed, and finally, the entity type may be detected by using the constructed AC tree. If the AC tree matches successfully, intention recognition is performed only based on the matched entity and relationship to search for an answer. When the AC tree fails to match, the system matches the question thereof and a designed question template to obtain the answer.

The knowledge graph of the embodiment includes:
a triplet relationship is (x, y, z), where x is a start point, y is an end point, and z is a relationship, and the relationship in the figure is as follows:
(described question, license plate number, market bad description); (solution, market bad description, final measure of the whole vehicle);
(resulting in defect, market bad description, defect class); (solution, final measure of the whole vehicle, defect class);
(maintenance time, repair time, maintenance time); (repair time, license plate number, repair time);
(operating mileage, license plate number, operating mileage); (having, user name, license plate number); (defect class, troubleshooting solution, defect class); (troubleshooting solution, market bad description, troubleshooting solution);
(preliminary judgment, market bad description, preliminary judgment conclusion); (description, user name, market bad description)

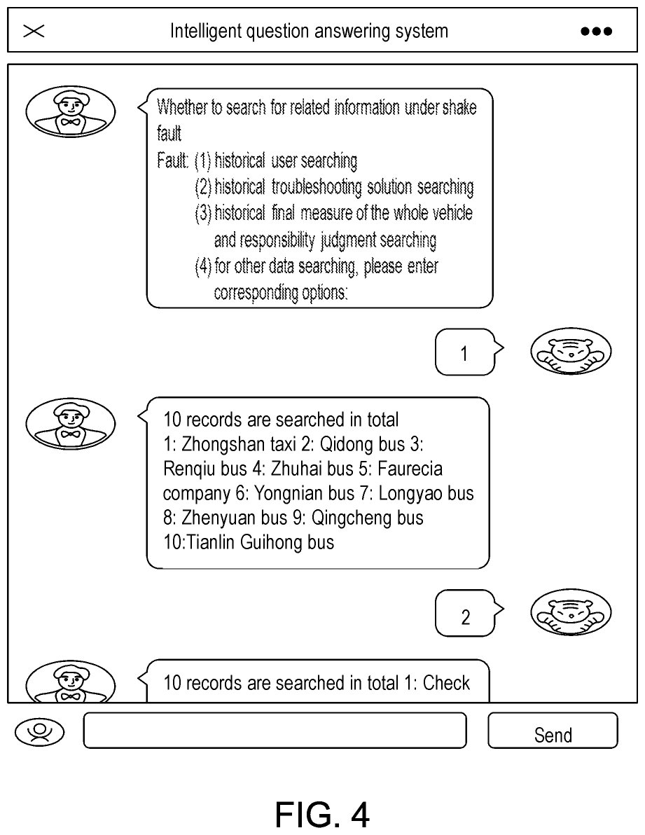

Referring to FIG. 1, inputting bad description of a vehicle to the model may judge a defect class that may occur, information such as a bad condition, a preliminary judgment result, a troubleshooting solution, and a measure that occur in the past of the defect class is extracted from a graph by means of the defect class, and a certain maintenance opinions are provided for a maintenance personnel. If it is found that a question is not in the existing questions subsequently, fault information of this class may be added to the graph, such that diagnosis details corresponding to various faults may be provided in a subsequent model diagnosis, providing more maintenance possibilities for the maintenance personnel with less experience. FIG. 4 is a vehicle fault question answering interface, and a user may interact with a system using the method by means of the interface.

A knowledge graph, with its rich semantic information and powerful reasoning and decision-making capabilities, provides efficient solutions for various intelligent applications in the Internet era. The knowledge graph is an important cornerstone of artificial intelligence, and efficient searching and processing is the basis for wide application of the knowledge graph. Therefore, in order to solve the existing problem of vehicle fault diagnosis at present, the present invention uses the knowledge graph to implement intelligent question answering of the vehicle fault diagnosis, implement a complete fault diagnosis system of vehicles, and improve the efficiency of fault diagnosis.

The method provided in the present invention has the following technical effects:
(1) The method provides a platform which may store knowledge of the vehicle fault and is more semantic than a traditional database.
(2) The constructed question answering system implements a set of complete process of word processing, question classification, question template matching, and answer generation, which may help the user to judge a fault problem of the vehicle, or may help the user to search for related knowledge about the vehicle fault, and have a certain research significance and value.

The above embodiments merely exemplarily illustrate the principle and effect of the present invention, and are not used to limit the present invention. Modifications and changes may be made to the above embodiments by anyone familiar with this technology without departing from the spirit and scope of the present invention. Therefore, all equivalent modifications or changes made by those with ordinary knowledge in the technical field without departing from the spirit and technical ideas disclosed by the present invention shall still be covered by the claims of the present invention.

What is claimed is:

1. A vehicle fault reasoning method based on a knowledge graph, comprises:
constructing a knowledge graph of a vehicle fault;
obtaining a question statement of a user;
performing question classification on the question statement by means of TextCNN to obtain a classification result;
performing sequence marking on a training question statement by using a method of NER marking sequence and training an entity extraction model based on a sequence marking result;
generating a vehicle fault class by using a decision tree model to make a decision on a result of the entity extraction model extracting the question statement and searching for an answer in the knowledge graph based on the vehicle fault class; and
performing question template matching based on the question classification result and the answer and substituting the answer into the question template to obtain an answer statement.

2. The vehicle fault reasoning method based on a knowledge graph according to claim 1, wherein the constructing a knowledge graph of a vehicle fault further comprises:
crawling Internet data related to the vehicle fault by means of a crawler and sorting out the Internet data combined with vehicle fault data into structured data; and
constructing the knowledge graph by using the structured data.

3. The vehicle fault reasoning method based on a knowledge graph according to claim 2, wherein the knowledge graph is a knowledge base using pictures to store and comprises an entity and a relationship; the entity is represented in a node form, and the relationship is used to represent a directed edge between nodes.

4. The vehicle fault reasoning method based on a knowledge graph according to claim 3, wherein the entity of the knowledge graph comprises: repair time, a license plate number, operating mileage, a user name, a defect class, market bad description, a troubleshooting solution, a preliminary judgment conclusion, a final measure of the whole vehicle, and responsibility judgment.

5. The vehicle fault reasoning method based on a knowledge graph according to claim 1, wherein the entity extraction model is a BiLSTM-CRF model comprising an Embedding layer, a two-way LSTM layer, and a CRF layer.

6. The vehicle fault reasoning method based on a knowledge graph according to claim 1, wherein types of a voice text comprise fault recognition, factual questions, method questions, list questions, and other questions.

7. The vehicle fault reasoning method based on a knowledge graph according to claim 1, wherein the question template matching comprises: performing multi-pattern string matching by using an aho-corasick (AC) algorithm; and the AC algorithm comprising a Trie tree and a fail pointer, and the Trie tree comprising an AC tree of each entity type.
